(19) United States
(12) Patent Application Publication
(10) Pub. No.: US 2012/0249457 A1
(43) Pub. Date: Oct. 4, 2012

(54) UNGROUNDED TOUCH-SENSING INPUT DEVICE AND CONTROL DEVICE THEREOF

(75) Inventors: SHIH TZUNG CHOU, Hsinchu County (TW); TSUNG LIN WU, Taipei County (TW); KAI MING LIU, Hsinchu County (TW)

(73) Assignee: RAYDIUM SEMICONDUCTOR CORPORATION, HSINCHU (TW)

(21) Appl. No.: 13/418,218

(22) Filed: Mar. 12, 2012

(30) Foreign Application Priority Data
Apr. 1, 2011 (TW) 100111478

(51) Int. Cl. G06F 3/041

(52) U.S. Cl. 345/173

(57) ABSTRACT

A control device of an ungrounded touch-sensing panel is disclosed. The touch-sensing panel includes a plurality of first-directional lines and a plurality of second-directional lines arranged intersecting one another. The control device includes a selection circuit, at least one capacitor, a driving signal generation circuit, an analog to digital conversion module and a signal processing unit. The selection circuit is configured to select at least one scan line and at least one sense line from the first-directional lines and the second-directional lines during each scanning operation. After the new scan line and sense line are generated, each capacitor is coupled between each scan line and each sense line selected by the selection circuit to increase a total capacitance between the scan line and the sense line.

### BACKGROUND

1. Technical Field

The present invention relates to an ungrounded touch-sensing input device and a control device thereof.

2. Related Art

Recently, touch-sensing panels have been widely applied in the fields of home appliance products, communication devices, and electronic information devices, among others. Touch-sensing panels are usually applied as input interfaces of consumer electronics, such as personal digital assistants (PDA), game consoles, etc. The recent trend of integrating a touch-sensing panel with a display screen allows a user to use a finger or a stylus to select an icon displayed on the panel, whereby the PDA, electronic product or game console executes the indicated function. This type of touch-sensing panel may also be applied in a public information query system, allowing the public to operate the system more efficiently.

FIG. 1 is a schematic diagram illustrating a prior art touch-sensing panel 10. The touch-sensing panel 10 includes a plurality of X-directional lines X₁-X_{M} and a plurality of Y-directional lines Y₁-Y_{N}, wherein M and N are different positive integers or the same positive integer. The X-directional lines X₁-X_{M} and the Y-directional lines Y₁-Y_{N} are buried in different layers of the touch-sensing panel 10. Referring to FIG. 1, the X-directional lines X₁-X_{M} and the Y-directional lines Y₁-Y_{N} are arranged intersecting one another so as to form a sensing grid. In the sensing grid, a parasitic mutual capacitor C_{M} is formed between each X-directional line and each Y-directional line, and each X-directional line and each Y-directional line respectively have a line capacitor connected to ground (not illustrated).

In a prior art operating method, a driving signal (usually a square wave signal) is input to an X-directional line or a Y-directional line. Through the coupling effect of mutual capacitors C_{M}, a plurality of induced voltages would be generated on the corresponding Y-directional lines or X-directional lines. Because the values of the induced voltages would change with how a user touches the lines, a touching position of the user can be determined by detecting differences of the induced voltages.

However, when the touch-sensing panel 10 is located in a device powered by an ungrounded power supply, and the device is covered by an insulating plastic shell, there would be a high impedance existing between a ground of the touch-sensing panel 10 and an earth ground of the user, and therefore the values of the induced voltages may be distorted due to the high impedance effect. When the distortion is severe, information on how the touch-sensing panel 10 is being touched, such as a touched position and a touched area may be incorrectly read. Hence, it is highly desirable to provide an improved structure for the ungrounded touch-sensing input device to address the foregoing problem.

### SUMMARY

The present invention is directed to a control device of an ungrounded touch-sensing panel. The touch-sensing panel includes a plurality of first-directional lines and a plurality of second-directional lines arranged intersecting one another. According to an embodiment, the touch-sensing device includes a selection circuit, at least one capacitor, a driving signal generation circuit, an analog to digital conversion module and a signal processing unit. The selection circuit is configured to select at least one scan line and at least one sense line from the first-directional lines and the second-directional lines during each scanning operation. The driving signal generation circuit is configured to generate a driving signal for the scan line selected by the selection circuit. Each capacitor is coupled between each scan line and each sense line selected by the selection circuit. The analog to digital conversion module is configured to receive a voltage on the scan line selected by the selection circuit, and convert the voltage to a digital signal. The signal processing unit is configured to perform calculation based on the digital signal to obtain touch information of the touch-sensing panel.

According to another embodiment, the touch-sensing panel also includes at least one first-directional dummy wire and at least one second-directional dummy wire. The control device includes a selection circuit, a driving signal generation circuit, an analog to digital conversion module and a signal processing unit. The selection circuit is configured to select at least one scan line and at least one sense line from the first-directional lines and the second-directional lines during each scanning operation. The driving signal generation circuit is configured to generate a driving signal for the scan line selected by the selection circuit. The analog to digital conversion module is configured to receive a voltage on the scan line selected by the selection circuit, and convert the voltage to a digital signal. The signal processing unit is configured to perform calculation based on the digital signal to obtain touch information of the touch-sensing panel. The at least one first-directional dummy wire is coupled to the scan line selected by the selection circuit, and the at least one second-directional dummy wire is coupled to the sense line selected by the selection circuit.

According to another embodiment, the control device is disposed on a substrate which includes at least one first redundancy trace and at least one second redundancy trace. The control device includes a selection circuit, a driving signal generation circuit, an analog to digital conversion module, and a signal processing unit. The selection circuit is configured to select at least one scan line and at least one sense line from the first-directional lines and the second-directional lines during each scanning operation. The driving signal generation circuit is configured to generate a driving signal for the scan line selected by the selection circuit. The analog to digital conversion module is configured to receive a voltage on the scan line selected by the selection circuit, and convert the voltage to a digital signal. The signal processing unit is configured to perform calculation based on the digital signal to obtain touch information of the touch-sensing panel. The at least one first redundancy trace is coupled to the scan line selected by the selection circuit, and the at least one second redundancy trace is coupled to the sense line selected by the selection circuit.

The present invention is also directed to an ungrounded touch-sensing input device. According to an embodiment, the touch-sensing input device includes a touch-sensing panel and a control device. The touch-sensing panel includes a plurality of first-directional lines, a plurality of second-directional lines, at least one first-directional dummy wire, and at least one second-directional dummy wire. The first-directional lines and the second directional-lines are arranged intersecting one another. The control device includes a selection circuit, a driving signal generation circuit, an analog to digital conversion module and a signal processing unit. The selection circuit is configured to select at least one scan line and at least one sense line from the first-directional lines and the second-directional lines during each scanning operation. The driving signal generation circuit is configured to generate a driving signal for the scan line selected by the selection circuit. The analog to digital conversion module is configured to receive a voltage on the scan line selected by the selection circuit, and convert the voltage to a digital signal. The signal processing unit is configured to perform calculation based on the digital signal to obtain touch information of the touch-sensing panel. The at least one first-directional dummy wire is coupled to the scan line selected by the selection circuit, and the at least one second-directional dummy wire is coupled to the sense line selected by the selection circuit.

According to another embodiment, the touch-sensing input device includes a touch-sensing panel, a substrate and a control device. The touch-sensing panel includes a plurality of first-directional lines, and a plurality of second-directional lines arranged intersecting one another. The substrate includes at least one first redundancy trace and at least one second redundancy trace. The control device includes a selection circuit, a driving signal generation circuit, an analog to digital conversion module and a signal processing unit. The selection circuit is configured to select at least one scan line and at least one sense line from the first-directional lines and the second-directional lines during each scanning operation. The driving signal generation circuit is configured to generate a driving signal for the scan line selected by the selection circuit. The analog to digital conversion module is configured to receive a voltage on the scan line selected by the selection circuit, and convert the voltage to a digital signal. The signal processing unit is configured to perform calculation based on the digital signal to obtain touch information of the touch-sensing panel. The at least one first redundancy trace is coupled to the scan line selected by the selection circuit, and the at least one second redundancy trace is coupled to the sense line selected by the selection circuit.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed might be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The objectives and advantages of the present invention will become apparent upon reading the following description and upon making reference to the accompanying drawings, in which:

FIG. 1 is a schematic diagram illustrating a prior art touch-sensing panel;

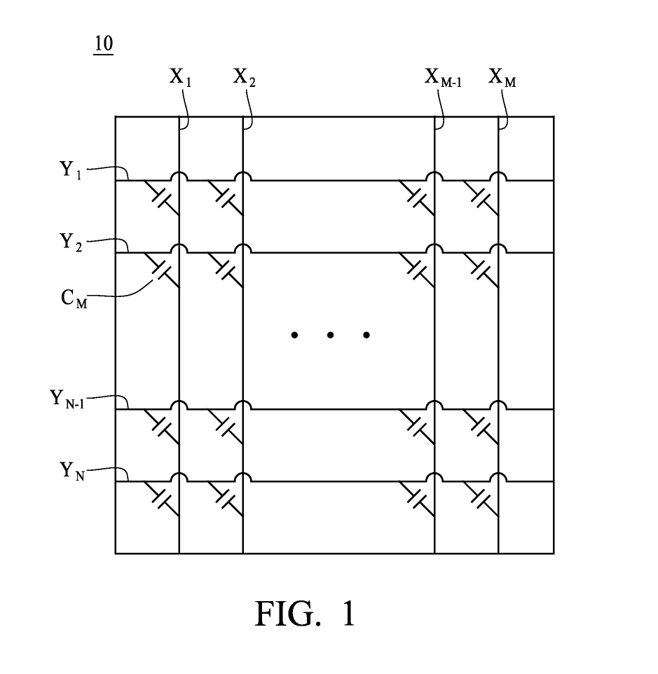

FIG. 2 is a schematic block diagram illustrating a touch-sensing input device according to an embodiment of the present invention;

FIG. 3 is a schematic block diagram illustrating a control device according to an embodiment of the present invention;

FIG. 4 illustrates a contacting situation of a human body and a touch-sensing panel;

FIG. 5 is a schematic block diagram illustrating a selection module according to an embodiment of the present invention;

FIG. 6 is a schematic block diagram illustrating a touch-sensing input device according to another embodiment of the present invention;

FIG. 7 is a schematic block diagram illustrating a selection module according to an embodiment of the present invention; and

FIG. 8 is a schematic layout diagram illustrating a control device according to another embodiment of the present invention.

### DESCRIPTION OF THE EMBODIMENTS

Detailed description of the preferred embodiments of the present invention is provided below with reference made to accompanying drawings, wherein similar reference numerals are used for the same or similar elements.

The term “ungrounded” used herein is interchangeable with the terms “poorly grounded” and “insulated”, and means poor grounding situation. That is, when an object is “ungrounded”, it does not have a zero or substantially low impedance with respect to the earth ground.

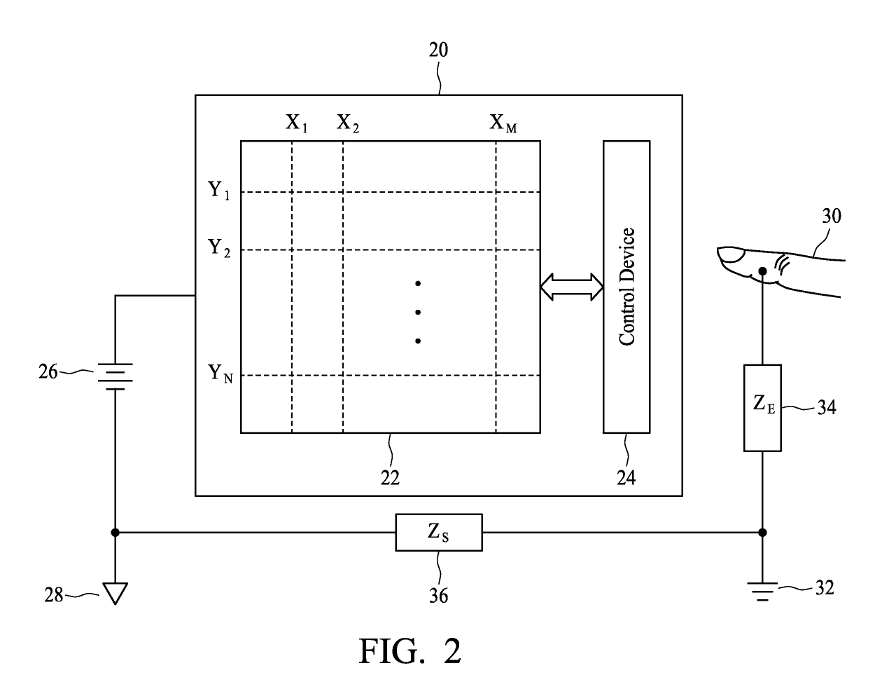

FIG. 2 is a schematic configuration diagram illustrating a touch-sensing input device 20, wherein the touch-sensing input device 20 includes a touch-sensing panel 22 and a control device 24. Referring to FIG. 2, the touch-sensing panel 22 includes a plurality of X-directional lines X₁-X_{M} and a plurality of Y-directional lines Y₁-Y_{N}. The X-directional lines and Y-directional lines are buried in different layers of the touch-sensing panel 22. Referring to FIG. 2, the X-directional lines X₁-X_{M} and the Y-directional lines Y₁-Y_{N} are arranged intersecting one another, whereby a rectangular sensing grid but not limited to a rectangular one is formed.

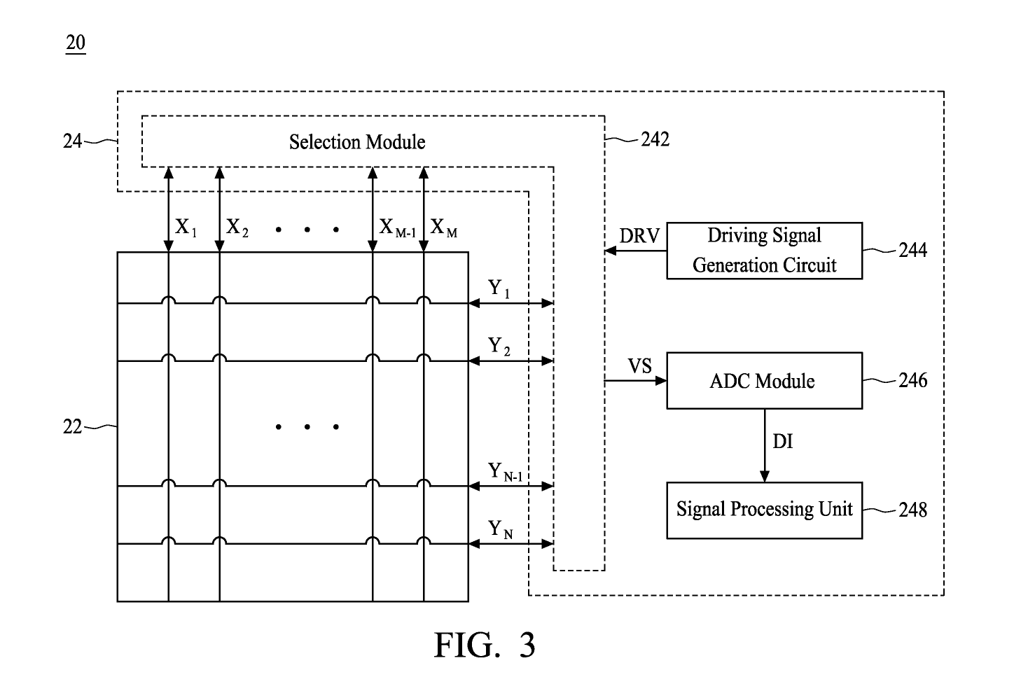

FIG. 3 is a schematic block diagram illustrating a control device 24 according to an embodiment. Referring to FIG. 3, the control device 24 includes a selection module 242, a driving signal generation circuit 244, an analog to digital conversion (ADC) module 246 and a signal processing unit 248. The selection module 242 is configured to select a scan line and a sense line from the X-directional lines X₁-X_{M} and the Y-directional lines Y₁-Y_{N} during each scanning operation. The driving signal generation circuit 244 is configured to generate a driving signal DRV for the scan line selected by the selection module 242. Moreover, the analog to digital convertor 246 is configured to receive a voltage VS on the sense line selected by the selection module 242, and convert the voltage VS to a digital signal DI. The signal processing unit 248 performs calculation based on the digital signal DI, whereby touching information of the touch-sensing panel 22 is obtained, such as a touched position and touched area of a user.

Referring to FIG. 2, the touch-sensing input device 20 is powered by a positive terminal of a battery 26, and a negative terminal of the battery 26 is connected to a ground 28. A conductor 30, a human finger part in the present embodiment, and an earth ground 32 have an impedance (Z_{E}) 34 therebetween. As illustrated in FIG. 2, there exists a system impedance (Z_{S}) 36 between the ground 28 and the earth ground 32. When the touch-sensing input device 20 is directly connected to a grounded wall outlet, the system impedance (Z_{S}) 36 would be close to zero. However, in the present embodiment, the touch-sensing input device 20 is powered by the battery 26, and the touch-sensing input device 20 is located within an insulating plastic shell (not illustrated), and therefore, the system impedance (Z_{S}) 36 is relatively high.

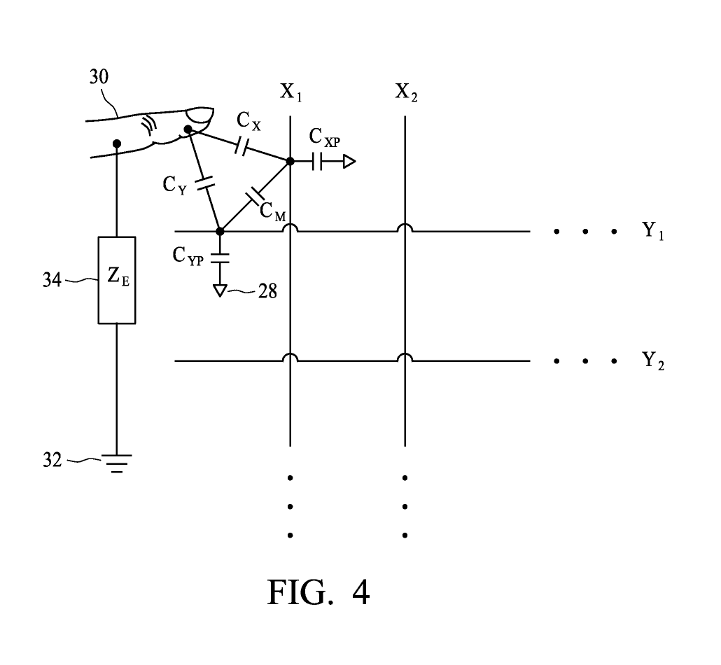

Referring to FIG. 4, there exists a parasitic mutual capacitor C_{M} between an X-directional line X₁ and a Y-directional line Y₁, and there exist line capacitors C_{XP} and C_{YP} respectively between the X-directional line X₁ and the ground 28, and the Y-directional line Y₁ and the ground 28. When the human finger 30 touches the touch-sensing panel 22, a human body capacitor C_{X} would be formed between the human finger 30 and the X-directional line X₁, and a human body capacitor C_{Y} would be formed between the human finger 30 and the Y-directional line Y₁. When the touch-sensing panel 22 is grounded (i.e., the system impedance (Z_{S}) 36 is substantially equal to zero), a high voltage level of the line X₁ may only be coupled to the line Y₁ through the mutual capacitor C_{M}. At this time, the human body capacitors C_{X} and C_{Y} are like being coupled to the earth ground. On the other hand, when the touch-sensing panel 22 is ungrounded (i.e., the system impedance (Z_{S}) exists between the ground 28 and the earth ground 32), a high voltage level of the line X₁ not only can be coupled to the line Y₁ through the mutual capacitor C_{M}, but also can be coupled to the line Y₁ through the human body capacitors C_{X} and C_{Y}. At this time, the equivalent capacitance, as a result of being ungrounded or poorly grounded, is approximate to a capacitor composed of the series connected capacitors C_{X} and C_{Y} connected in parallel with the mutual capacitor C_{M}. The aforementioned parallel connection effect may cause the voltage on the X-directional line or the Y-directional line to be distorted, and the real touched position unable to be calculated.

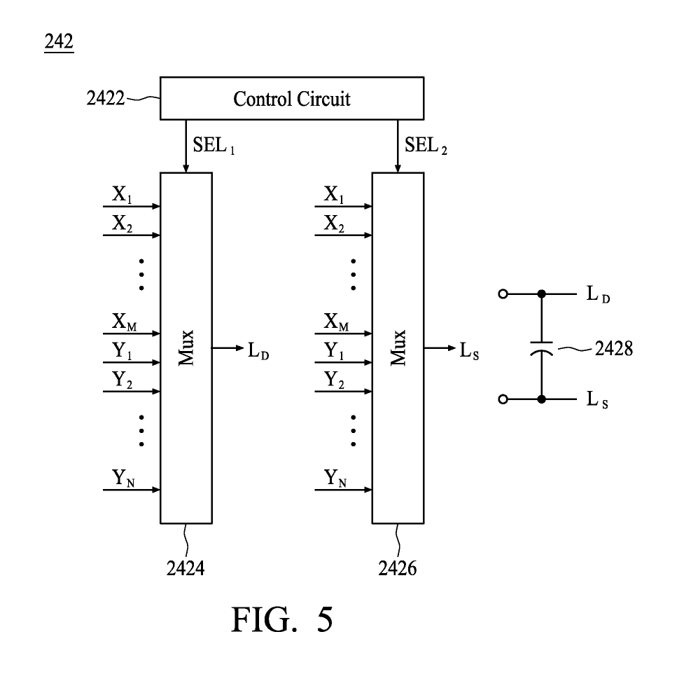

In order to reduce the coupling effect of the human body capacitors C_{X} and C_{Y} on an ungrounded device, in the disclosed devices of the present invention, an additional capacitor is configured equivalently in parallel with the mutual capacitor C_{M}, to increase the equivalent capacitance between the X-directional line and the Y-directional line. According to an embodiment, the additional capacitor is configured in the control device 24, e.g., within the selection module 244. FIG. 5 is a block diagram illustrating the selection module 242 according to an embodiment. Referring to FIG. 5, the selection module 242 includes a control circuit 2422, multiplexers (Mux) 2424 and 2426 and a capacitor 2428. The control circuit 2422 is configured to generate selection signals SEL₁ and SEL₂ based on a predetermined scanning sequence to be provided to the multiplexers 2424 and 2426. The multiplexers 2424 and 2426 are configured to select at least one scan line and at least one sense line from the X-directional lines X₁-X_{M} and Y-directional lines Y₁-Y_{N} in response to the selection signals SEL₁ and SEL₂. In order to simplify the description, a scan line L_{D} and a sense line L_{S} is used to describe the operation principle. During each scanning operation, the driving signal DRV would be applied to the scan line L_{D}. Thereafter, a voltage on the sense line L_{S} would be received and converted into a digital signal DI by the analog to digital conversion module 246 shown in FIG. 3.

Referring to FIG. 5, in the present embodiment, the capacitor 2428 is coupled between the scan line L_{D} and the sense line L_{S}. Therefore, when the selection module 242 selects a new scan line L_{D} and sense line L_{S} during each scanning operation, the equivalent capacitance between the scan line L_{D} and the sense line L_{S} is the capacitance of the original mutual capacitor plus the capacitor 2428. Thus, the equivalent capacitance between the scan line L_{D} and the sense line L_{S} would increase. According to the charge sharing principle, the coupling effect of the human body capacitors C_{X} and C_{Y} on the ungrounded device can be effectively reduced.

According to an embodiment, the control device 24 may be implemented with an integrated circuit. Therefore, the capacitor 2428 may be an integrated circuit capacitor. According to another embodiment, the capacitor 2428 is a discrete capacitor, i.e., the capacitor 2428 is an externally connected capacitor.

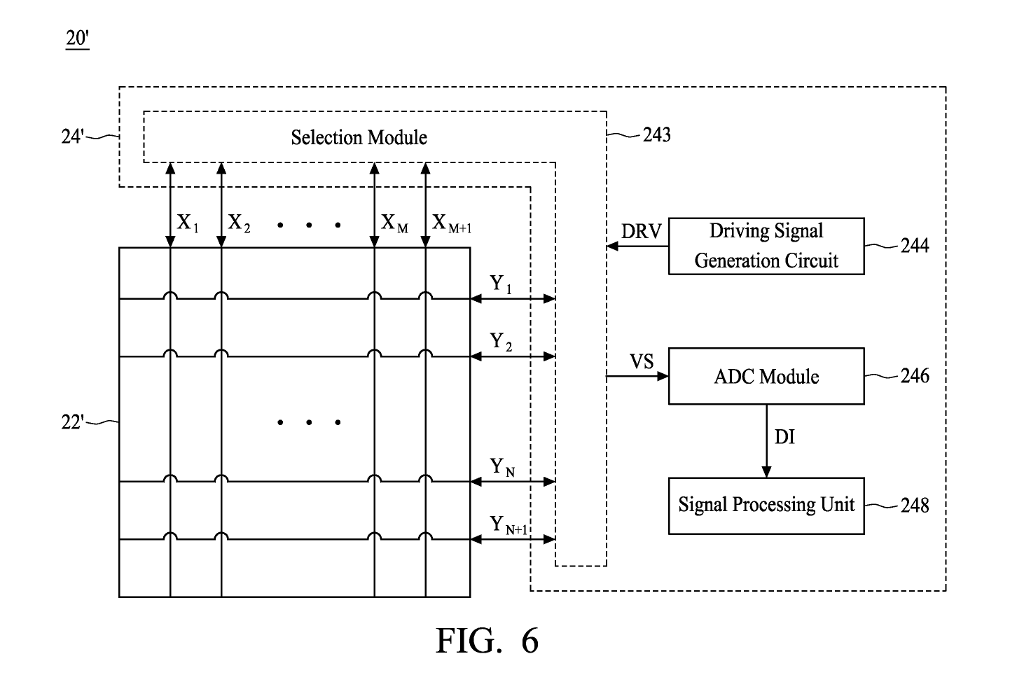

According to another embodiment, the equivalent capacitance between the scan line L_{D} and the sense line L_{S} may be increased by an existing stray capacitor. The stray capacitor may be originated from one or multiple dummy wires. FIG. 6 is a block diagram illustrating a touch-sensing input device 20′ according to another embodiment, wherein the touch-sensing input device 20′ includes a touch-sensing panel 22′ and a control device 24′. Referring to FIG. 6, the touch-sensing panel 22′ includes a plurality of X-directional lines X₁-X_{M}, a plurality of Y-directional lines Y₁-Y_{N}, at least one X-directional dummy wire X_{M+1} and at least one Y-directional dummy wire Y_{N+1}. For simplification purpose, an X-directional dummy wire X_{M+1} and a Y-directional dummy wire Y_{N+1} located at border areas are used as an example for description. However, the present invention is not limited to such implementation. There may be a plurality of X-directional dummy wires and Y-directional dummy wires, and an X-directional dummy wire and a Y-directional dummy wire may be disposed on any position of the touch-sensing panel 22′.

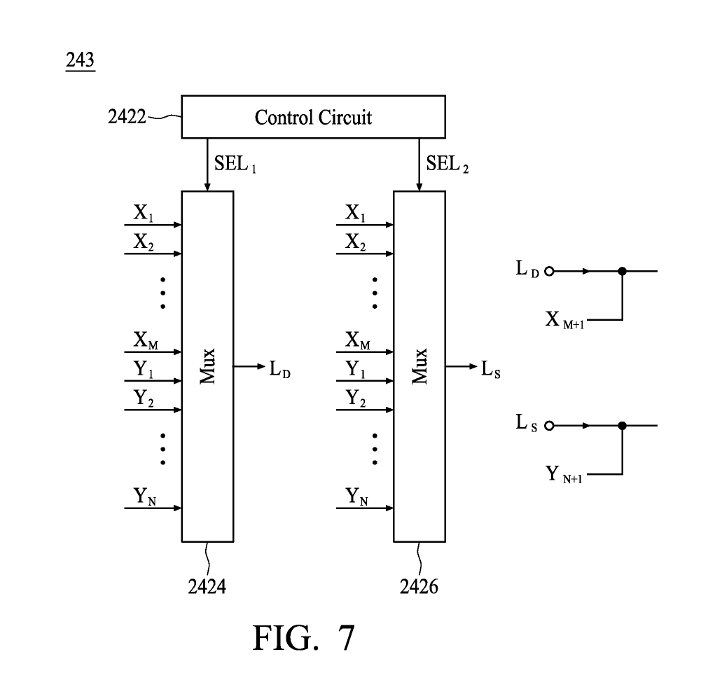

Referring to FIG. 6, the touch-sensing device 24′ includes a selection module 243, a driving signal generation circuit 244, an analog to digital conversion module 246 and a signal processing unit 248. FIG. 7 is a schematic block diagram illustrating the selection module 243 according to an embodiment. Referring to FIG. 7, the selection module 243 includes a control circuit 2422, multiplexers 2424 and 2426. As described previously, the multiplexers 2424 and 2426 are configured to select a scan line L_{D} and a sense line L_{S} from the X-directional lines X₁-X_{M} and the Y-directional lines Y₁-Y_{N}. After the new scan line L_{D} and the sense line L_{S} are produced, the X-directional dummy wire X_{M+1} on the touch-sensing panel 22′ is coupled to the new scan line L_{D}, and the Y-directional dummy wire Y_{N+1} on the touch-sensing panel 22′ is coupled to the new sense line L_{S}. In such manner, the equivalent capacitance between the scan line L_{D} and the sense line L_{S} would be increased by means of the dummy wire X_{M+1} and dummy wire Y_{N+1}. According to the charging sharing principle, the coupling effect of the human body capacitors C_{X} and C_{Y} on the ungrounded device can be effectively reduced.

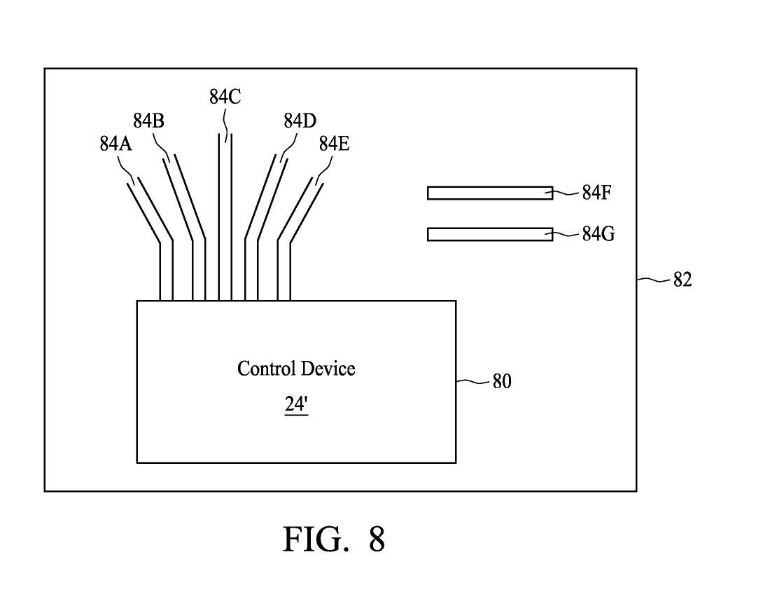

According to yet another embodiment, the equivalent capacitance between the scan line L_{D} and the sense line L_{S} may be increased by a discrete capacitor on a printed circuit board (PCB). The discrete capacitor may originate from one or a plurality of redundancy traces. FIG. 8 is a schematic layout diagram illustrating a control device 24′ according to another embodiment, wherein the control device 24′ is implemented with a chip, and the chip is protected by a package 80. The control device 24′ is disposed on a PCB 82. Referring to FIG. 8, a plurality of traces 84A-84H are disposed on the PCB 82, wherein the traces 84A-84E are communication traces between the control device 24′ and the touch-sensing panel 22′ and the trace 84F and the trace 84G are redundancy traces. That is, the trace 84F and the trace 84G are not coupled to any voltage level before a scanning operation.

According to the present embodiment, the multiplexers 2424 and 2426 in the selection module 243 select a scan line L_{D} and a sense line L_{S} from the X-directional lines X₁-X_{M} and the Y-directional lines Y₁-Y_{N} in response to selection signals SEL₁ and SEL₂. After the new scan line L_{D} and sense line L_{S} are generated, the trace 84F on the PCB 82 would be coupled to the new scan line L_{D}, and the trace 84G on the PCB 82 would be coupled to the new sense line L_{S}. In this manner, the equivalent capacitance between the scan line L_{D} and the sense line L_{S} would be increased due to the redundancy traces 84F and 84G. According to the charge sharing principle, the coupling effect of the human body capacitors C_{X} and C_{Y} on the ungrounded device can be effectively reduced.

Although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A control device applied in an ungrounded touch-sensing panel, the touch-sensing panel comprising a plurality of first-directional lines and a plurality of second-directional lines, the first-directional lines and the second-directional lines being arranged intersecting one another, the control device comprising:
a selection circuit, configured to select at least one scan line and at least one sense line from the first-directional lines and the second-directional lines during each scanning operation;
a driving signal generation circuit, configured to generate a driving signal for the scan line selected by the selection circuit;
at least one capacitor, each capacitor being coupled between each scan line and each sense line selected by the selection circuit;
an analog to digital conversion module, configured to receive a voltage on the scan line selected by the selection circuit, and convert the voltage to a digital signal; and
a signal processing unit, configured to perform calculation based on the digital signal to obtain touch information of the touch-sensing panel.

2. The control device according to claim 1, wherein the selection circuit comprises:
a control circuit, configured to generate a selection signal based on a predetermined scanning sequence;
a first multiplexer, configured to select the at least one scan line from the first-directional lines and the second-directional lines in response to the selection signal; and
a second multiplexer, configured to select the at least one sense line from the first-directional lines and the second-directional lines in response to the selection signal,
wherein when the at least one scan line is one of the first-directional lines, the at least one sense line is one of the second-directional lines.

3. The control device according to claim 1, wherein the at least one capacitor is an integrated circuit capacitor.

4. The control device according to claim 1, wherein the at least one capacitor is a discrete capacitor.

5. A control device applied in an ungrounded touch-sensing panel, the touch-sensing panel comprising a plurality of first-directional lines and a plurality of second-directional lines, at least one first-directional dummy wire, and at least one second-directional dummy wire, the first-directional lines and the second-directional lines being arranged intersecting one another, the control device comprising:
a selection circuit, configured to select at least one scan line and at least one sense line from the first-directional lines and the second-directional lines during each scanning operation;
a driving signal generation circuit, configured to generate a driving signal for the scan line selected by the selection circuit;
an analog to digital conversion module, configured to receive a voltage on the scan line selected by the selection circuit, and convert the voltage to a digital signal; and
a signal processing unit, configured to perform calculation based on the digital signal to obtain touch information of the touch-sensing panel,
wherein the at least one first-directional dummy wire is coupled to the scan line selected by the selection circuit, and the at least one second-directional dummy wire is coupled to the sense line selected by the selection circuit.

6. The control device according to claim 5, wherein the selection circuit comprises:
a control circuit, configured to generate a selection signal based on a predetermined scanning sequence;
a first multiplexer, configured to select the at least one scan line from the first-directional lines and the second-directional lines in response to the selection signal; and
a second multiplexer, configured to select the at least one sense line from the first-directional lines and the second-directional lines in response to the selection signal,
wherein when the at least one scan line is one of the first-directional lines, the at least one sense line is one of the second-directional lines.

7. An ungrounded touch-sensing input device, comprising:
a touch-sensing panel, comprising:
a plurality of first-directional lines;
a plurality of second-directional lines;
at least one first-directional dummy wire; and
at least one second-directional dummy wire;
wherein the first-directional lines and the second conductive lines are arranged intersecting one another; and
a control device, comprising:
a selection circuit, configured to select at least one scan line and at least one sense line from the first-directional lines and the second-directional lines during each scanning operation;
a driving signal generation circuit, configured to generate a driving signal for the scan line selected by the selection circuit;
an analog to digital conversion module, configured to receive a voltage on the scan line selected by the selection circuit, and convert the voltage to a digital signal; and
a signal processing unit, configured to perform calculation based on the digital signal to obtain touch information of the touch-sensing panel,
wherein the at least one first-directional dummy wire is coupled to the scan line selected by the selection circuit, and the at least one second-directional dummy wire is coupled to the sense line selected by the selection circuit.

8. The touch-sensing input device according to claim 7, wherein the selection circuit comprises:
a control circuit, configured to generate a selection signal based on a predetermined scanning sequence;
a first multiplexer, configured to select the at least one scan line from the first-directional lines and the second-directional lines in response to the selection signal; and
a second multiplexer, configured to select the at least one sense line from the first-directional lines and the second-directional lines in response to the selection signal,
wherein when the at least one scan line is one of the first-directional lines, the at least one sense line is one of the second-directional lines.

9. A control device applied in an ungrounded touch-sensing panel, the touch-sensing panel comprising a plurality of first-directional lines and a plurality of second-directional lines, the first-directional lines and the second-directional lines being arranged intersecting one another, the control device being disposed on a substrate, the substrate comprising at least one first redundancy trace and at least one second redundancy trace, the control device comprising:
a selection circuit, configured to select at least one scan line and at least one sense line from the first-directional lines and the second-directional lines during each scanning operation;
a driving signal generation circuit, configured to generate a driving signal for the scan line selected by the selection circuit;
an analog to digital conversion module, configured to receive a voltage on the scan line selected by the selection circuit, and convert the voltage to a digital signal; and
a signal processing unit, configured to perform calculation based on the digital signal to obtain touch information of the touch-sensing panel,
wherein the at least one first redundancy trace is coupled to the scan line selected by the selection circuit, and the at least one second redundancy trace is coupled to the sense line selected by the selection circuit.

10. The control device according to claim 9, wherein the selection circuit comprises:
a control circuit, configured to generate a selection signal based on a predetermined scanning sequence;
a first multiplexer, configured to select the at least one scan line from the first-directional lines and the second-directional lines in response to the selection signal; and
a second multiplexer, configured to select the at least one sense line from the first-directional lines and the second-directional lines in response to the selection signal,
wherein when the at least one scan line is one of the first-directional lines, the at least one sense line is one of the second-directional lines.

11. An ungrounded touch-sensing input device, comprising:
a touch-sensing panel, comprising:
a plurality of first-directional lines; and
a plurality of second-directional lines,
wherein the first-directional lines and the second-directional lines are arranged intersecting one another;
a substrate, comprising at least one first redundancy trace and at least one second redundancy trace; and
a control device, comprising:
a selection circuit, configured to select at least one scan line and at least one sense line from the first-directional lines and the second-directional lines during each scanning operation;
a driving signal generation circuit, configured to generate a driving signal for the scan line selected by the selection circuit;
an analog to digital conversion module, configured to receive a voltage on the scan line selected by the selection circuit, and convert the voltage to a digital signal; and
a signal processing unit, configured to perform calculation based on the digital signal to obtain touch information of the touch-sensing panel,
wherein the at least one first redundancy trace is coupled to the scan line selected by the selection circuit, and the at least one second redundancy trace is coupled to the sense line selected by the selection circuit.

12. The touch-sensing input device according to claim 11, wherein the selection circuit comprises:
a control circuit, configured to generate a selection signal based on a predetermined scanning sequence;
a first multiplexer, configured to select the at least one scan line from the first-directional lines and the second-directional lines in response to the selection signal; and
a second multiplexer, configured to select the at least one sense line from the first-directional lines and the second-directional lines in response to the selection signal,
wherein when the at least one scan line is one of the first-directional lines, the at least one sense line is one of the second-directional lines.
